(19) United States
(12) Patent Application Publication
(10) Pub. No.: US 2015/0140301 A1
(43) Pub. Date: May 21, 2015

(54) LAMINATED GLASS STRUCTURES HAVING HIGH GLASS TO POLYMER INTERLAYER ADHESION

(71) Applicant: CORNING INCORPORATED, CORNING, NY (US)

(72) Inventors: William Keith Fisher, Suffield, CT (US); Mark Stephen Friske, Campbell, NY (US)

(21) Appl. No.: 14/405,647

(22) PCT Filed: Jun. 6, 2013
(86) PCT No.: PCT/US2013/044483

§ 371 Date: Dec. 4, 2014

Related U.S. Application Data
(60) Provisional application No. 61/657,182, filed on Jun. 8, 2012.

(51) Int. Cl. B32B 17/10; B32B 37/18

(52) U.S. Cl. CPC B32B 17/10036; B32B 17/10137; B32B 17/10688; B32B 17/10761; B32B 37/182
USPC 428/215; 156/99

(57) ABSTRACT

A thin glass laminate is provided including at least one or two thin glass sheets with at least one polymer interlayer laminated therebetween. The laminate has a high level of adhesion between the two glass sheets and the interlayer, such that the laminate has a pummel value of at least 7, at least 8, or at least 9. The laminate also has a high penetration resistance of at least 20 feet mean break height. The polymer interlayers have a thickness ranging from about 0.5 mm to about 2.5 mm and are formed of an ionomer, poly vinyl butyral, or polycarbonate. At least one or both of the two glass sheets are chemically strengthened.

### CROSS REFERENCES

The present application is co-pending with and claims the priority benefit of the provisional application entitled, “Laminated Glass Structures Having High Glass to Polymer Interlayer Adhesion,” Application Ser. No. 61/657,182, filed on Jun. 8, 2012, the entirety of which is incorporated herein by reference

### BACKGROUND

The present disclosure relates generally to laminated glass structures, and more particularly to laminate structures having a high adhesion between a polymer interlayer and at least one glass sheet, which structures can be used in automotive glazing and other vehicle and architectural applications.

Glass laminates can be used as windows and glazing in architectural and vehicle or transportation applications, including automobiles, rolling stock, locomotive and airplanes. Glass laminates can also be used as glass panels in balustrades and stairs, and as decorative panels or covering for walls, columns, elevator cabs and other architectural applications. Glass laminates can be used as glass panels or covers for signs, displays, appliances, electronic device and furniture. Common types of glass laminates employed in architectural and vehicle applications include clear and tinted laminated glass structures. As used herein, a glazing or a laminated glass structure (e.g., a glass laminate) can be a transparent, semi-transparent, translucent, or opaque part of a window, panel, wall or other structure having at least one glass sheet laminated to a polymeric layer, film or sheet. Laminated structures can also be used as a cover glass on signage, electronic displays, electronic devices and appliances, as well as a host of other applications.

Penetration resistance of such glass laminates can be determined using a 2.27 kg (5 lb.) ball drop test where a Mean Break Height (MBH) is commonly measured via staircase or energy methods. MBH is generally defined as the ball drop height at which 50% of samples would hold the ball and 50% would allow penetration. Automotive windshields for use in vehicles in the United States, for example, must pass a minimum penetration resistance specification (100% pass at 12 feet) found in the ANSI Z26.1 code. Similar codes are also present in other countries. Additionally, there are specific code requirements in both the US and Europe for use of laminated glass in architectural applications wherein minimum penetration resistance must be met.

The staircase method utilizes an impact tower from which a steel ball is dropped from various heights onto a sample. The test laminate is then supported horizontally in a support frame similar to that described in the ANSI Z26.1 code. If necessary, an environmental chamber can be used to condition laminates to a desired test temperature. The test is performed by supporting the sample in the support frame and dropping a ball onto the laminate sample from a height near the expected MBH. If the ball penetrates the laminate, the result is recorded as a failure, and if the ball is supported, the result is recorded as a hold. If the result is a hold, the process is repeated from a drop height 0.5 m higher than the previous test. If the result is a failure, the process is repeated at a drop height 0.5 m lower than the previous test. This procedure is repeated until all of the test samples have been used. Results of the procedure are then tabulated, a percent hold at each drop height is calculated, and then a graph provided as percent hold versus height with a line representing the best fit of the data thereon corresponding to an MBH where there is a 50% probability that a 5 lb. ball will penetrate a laminate.

Adhesion of polymer interlayers to the glass sheets can be measured using a pummel adhesion test (pummel adhesion value has no units). The pummel adhesion test is a standard method of measuring adhesion of glass to PVB or other interlayers in laminated glass. The test includes conditioning laminates at 0 F (−18 C) for a predetermined time followed by pummeling or impacting the samples with a 1 lb. hammer to shatter the glass. Adhesion is judged by the amount of exposed PVB resulting from glass that has fallen off of the PVB interlayer. All broken glass un-adhered to the interlayer sheet is removed. The glass left adhered to the interlayer sheet is visually compared with a set of standards of known pummel scale. For example, the higher the number, the more glass that remained adhered to the sheet, i.e., a pummel adhesion value of zero means that no glass remained adhered to the interlayer, and a pummel value of 10 means that 100% of the glass remained adhered to the interlayer. To achieve acceptable penetration resistance (or impact strength) for typical glass/PVB/glass laminates, interfacial glass/PVB adhesion levels should be maintained at about 3-7 Pummel units. Acceptable penetration resistance is achieved for typical glass/PVB/glass laminates at a pummel adhesion value of 3 to 7, preferably 4 to 6. At a pummel adhesion value of less than 2, too much glass is generally lost from the sheet and glass in typical glass/PVB/glass during impact and problems with laminate integrity (i.e., delamination) and long term durability that can also occur. At a pummel adhesion value of more than 7, adhesion of the glass to the sheet is generally too high in typical glass/PVB/glass and can result in a laminate with poor energy dissipation and low penetration resistance.

Glazing constructions typically include two plies of 2 mm thick soda lime glass (heat treated or annealed) with a polyvinyl butyral (PVB) interlayer. These laminate constructions have certain advantages, including, low cost, and a sufficient impact resistance and stiffness for automotive and other applications. However, because of their limited impact resistance, these laminates usually have a poor behavior and a higher probability of breakage when struck by roadside stones, vandals and/or other impact events. Most automotive laminated glass structures employ an PVB interlayer material. To achieve acceptable adhesion of the PVB interlayer to the glass and to achieve penetration resistance, control salts or other adhesion inhibitors are added to the conventional PVB formulations to decrease the adhesion of the PVB film to the glass. Decreasing the adhesion of the PVB interlayer to the glass, however, has the undesirable effect of reducing post-breakage glass retention. For ionomeric interlayers which are widely used in architectural applications, e.g., SentryGlas® from DuPont, an adhesion promoter is often required to increase the adhesion of the ionomeric interlayer to the glass.

### SUMMARY

In many vehicular applications, fuel economy is a function of vehicle weight. It is desirable, therefore, to reduce the weight of glazings or laminates for such applications without compromising their strength and sound-attenuating properties. In view of the foregoing, thinner, economical glazings or glass laminates that possess or exceed the durability, sound-damping and breakage performance properties associated with thicker, heavier glazings are desirable.

The present disclosure relates to glass laminates for automotive, architectural and other applications with a high level of adhesion between at least one chemically strengthened thin glass sheet and at least one polymer layer, such as a PVB layer or SentryGlas® layer. Laminates according to the present disclosure have a high adhesion between the glass and a polymer layer and also have outstanding post-breakage glass retention properties. Laminates as described herein can also demonstrate a combination of high adhesion and high penetration resistance, which is contrary to poor penetration resistance at high adhesion exhibited by conventional soda lime glass and PVB laminates. Furthermore, laminates of the present disclosure do not need adhesion control agents to provide acceptable penetration resistance or adhesion of the PVB or SentryGlas® layer to glass. By contrast, conventional soda lime glass/PVB laminates exhibit poor penetration resistance at high adhesion levels. In addition, in some embodiments that laminate a sheet of PVB to an exemplary sheet of glass, the high penetration resistance of the resulting glass laminate can eliminate the need for an adhesion inhibitor when bonding the PVB to the glass sheet. In other embodiments that laminate a sheet of SentryGlas® to an exemplary sheet of glass, the high adhesion of chemically strengthened glass to SentryGlas® can eliminate the need for an adhesion promoter when bonding the SentryGlas® to the glass sheet. Moreover, the high adhesion between the thin chemically strengthened glass sheet and the SentryGlas® does not depend on which side of the glass sheet the SentryGlas® contacts, as is the case when laminating SentryGlas® to soda lime glass.

According to an embodiment of the present disclosure, a glass laminate structure can be provided having two glass sheets with a thickness of less than 2 mm, and a polymer interlayer between the two glass sheets with an adhesion to the two glass sheets such that the laminate has a pummel value of at least 7, at least 8, or at least 9. Polymer interlayers in glass laminates as described herein can have thickness ranging from about 0.5 mm to about 2.5 mm. According to other embodiments, the laminate can have a penetration resistance of at least 20 feet mean break height (MBH). At least one of the two glass sheets can be chemically strengthened. Of course, both of the two glass sheets can be chemically strengthened and can also have a thickness not exceeding 1.5 mm. Additionally, any one of the two glass sheets can be annealed, cured or partially strengthened. In further embodiments, at least one of the two glass sheets can have a thickness not exceeding 2 mm, not exceeding 1.5 mm or not exceeding 1 mm. Exemplary interlayers can be formed of an ionomer, a polyvinyl butyral (PVB), or other suitable polymer. Ionomer interlayers (such as SentryGlas® from DuPont) in glass laminates as described herein can have thickness ranging from about 0.5 mm to about 2.5 mm, or from 0.89 mm to about 2.29 mm. PVB interlayers in glass laminates as described herein can have a thickness in a range from about 0.38 mm to about 2 mm, or from about 0.76 mm to about 0.81 mm.

The present disclosure also describes a process of forming a glass laminate structure comprising the steps of providing a first glass sheet a second glass sheet and a polyvinyl butyral interlayer, stacking the interlayer on top of the first glass sheet, and stacking the second glass sheet on the interlayer to form an assembled stack. The process also includes heating the assembled stack to a temperature at or above the softening temperature of the interlayer to laminate the interlayer to the first glass sheet and the second glass sheet whereby adhesion inhibitors are not employed between the interlayer and the first glass sheet and the second glass sheet, such that the interlayer is bonded to the two glass sheets with an adhesion having a pummel value of at least 7.

The present disclosure also describes a process of forming a glass laminate structure comprising the steps of providing a first glass sheet a second glass sheet and an ionomer interlayer, stacking the interlayer on top of the first glass sheet, and stacking the second glass sheet on the interlayer to form an assembled stack. The process also includes heating the assembled stack to a temperature at or above the softening temperature of the interlayer to laminate the interlayer to the first glass sheet and the second glass sheet whereby adhesion promoters are not employed between the interlayer and the first glass sheet and the second glass sheet, such that the interlayer is bonded to the two glass sheets with an adhesion having a pummel value of at least 7.

Additional features and advantages will be set forth in the detailed description which follows, and in part will be readily apparent to those skilled in the art from the description or recognized by practicing the embodiments as described in the written description and claims hereof, as well as the appended drawings. It is to be understood that both the foregoing general description and the following detailed description are merely exemplary, and are intended to provide an overview or framework to understand the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a cross-sectional illustration of a laminated glass structure according an embodiment of the present description.

FIG. 2 is a cross-sectional illustration of a laminated glass structure according to another embodiment of the present description.

FIG. 3 is a plot of depth of layer versus compressive stress for various glass sheets according to several embodiments.

FIG. 4 is a plot of penetration resistance versus adhesion for soda lime glass/PVB laminates.

### DETAILED DESCRIPTION

With reference to the figures, where like elements have been given like numerical designations to facilitate an understanding of the present subject matter, the various embodiments for laminated glass structures having high glass to polymer interlayer adhesion are described.

The following description of the present subject matter is provided as an enabling teaching and its best, currently-known embodiment. Those skilled in the art will recognize that many changes can be made to the embodiments described herein while still obtaining the beneficial results of the present subject matter. It will also be apparent that some of the desired benefits of the present subject matter can be obtained by selecting some of the features of the present subject matter without utilizing other features. Accordingly, those who are skilled in the art will recognize that many modifications and adaptations of the present subject matter are possible and can even be desirable in certain circumstances and are part of the present disclosure. Thus, the following description is provided as illustrative of the principles of the present subject matter and not in limitation thereof.

Those skilled in the art will appreciate that many modifications to the exemplary embodiments described herein are possible without departing from the spirit and scope of the present subject matter. Thus, the description is not intended and should not be construed to be limited to the examples given but should be granted the full breadth of protection afforded by the appended claims and equivalents thereto. In addition, it is possible to use some of the features of the present subject matter without the corresponding use of the other features. Accordingly, the foregoing description of exemplary or illustrative embodiments is provided for the purpose of illustrating the principles of the present subject matter and not in limitation thereof and can include modification thereto and permutations thereof.

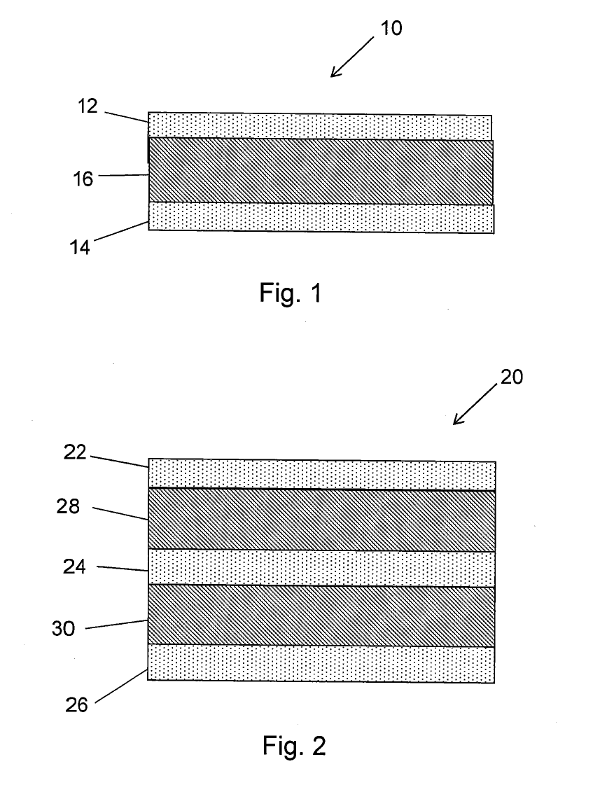

FIG. 1 is a cross-sectional illustration of a glass laminate structure 10 according to some embodiments. With reference to FIG. 1, a laminate structure 10 can include two glass sheets 12 and 14 laminated on either side of a polymeric interlayer 16. At least one of the glass sheets 12 and 14 can be formed of glass chemically strengthened by, for example, an ion exchange process. The polymer interlayer 16 can be, but is not limited to, a PVB or an ionomeric material such as SentryGlas®. An example of a stiff PVB is Saflex DG from Solutia. By way of further example, the interlayer can be formed of a standard PVB, acoustic PVB, ethylene vinyl acetate (EVA), thermoplastic polyurethane (TPU), or other suitable polymer or thermoplastic material.

According to another embodiment hereof, the glass sheets can be formed of thin glass sheets that have been chemically strengthened using an ion exchange process, such as Corning® Gorilla® glass. In this type of process, the glass sheets are typically immersed in a molten salt bath for a predetermined period of time. Ions within the glass sheet at or near the surface of the glass sheet are exchanged for larger metal ions, for example, from the salt bath. In one non-limiting embodiment, the temperature of the molten salt bath is about 430° C. and the predetermined time period is about eight hours. The incorporation of the larger ions into the glass strengthens the glass sheet by creating a compressive stress in a near surface region. A corresponding tensile stress can be induced within a central region of the glass sheet to balance the compressive stress.

“Thin” as used in relation to the glass sheets described herein means glass sheets having a thickness not exceeding 2.0 mm, not exceeding 1.5 mm, not exceeding 1.0 mm, not exceeding 0.7 mm, not exceeding 0.5 mm, or within a range from about 0.5 mm to about 2.0 mm, from about 0.5 mm to about 1.5 mm, or from about 0.5 mm to about 1.0 mm or from about 0.5 mm to about 0.7 mm.

Polymer interlayers in glass laminates as described herein can have thicknesses ranging from about 0.5 mm to about 2.5. Ionomer interlayers (such as SentryGlas from DuPont) in glass laminates as described herein can have thicknesses ranging from about 0.5 mm to about 2.5 mm, or from 0.89 mm to about 2.29 mm. PVB interlayers in glass laminates as described herein can have a thickness in a range from about 0.38 mm to about 2 mm, or from about 0.76 mm to about 0.81 mm.

As described in U.S. Pat. Nos. 7,666,511, 4,483,700 and 5674790, Corning® Gorilla® Glass can be made by fusion drawing a glass sheet and then chemically strengthening the glass sheet. As described in more detail hereinafter, Corning® Gorilla® Glass has a deep depth of layer (DOL) of compressive stress, and presents surfaces having a high flexural strength, scratch resistance and impact resistance. The glass sheets 12 and 14 and the polymer interlayer 16 can be bonded together during a lamination process in which the glass sheet 12, interlayer 16 and glass sheet 14 are stacked one on top of the other, pressed together and heated to a temperature above the softening temperature of the interlayer material, such that the interlayer 16 adheres to the glass sheets.

Glass laminates made using Gorilla® Glass as one or both of the outer glass sheets 12 and 14 and a PVB interlayer 16 demonstrate both high adhesion (i.e., good post-breakage glass retention) and excellent penetration resistance. Testing of glass laminates made using 0.76 mm thick high adhesion grade (RA) PVB with two sheets of 1 mm thick Gorilla® Glass demonstrated high pummel adhesion values in a range from about 9 to about 10. Thin glass laminates with PVB interlayers according to the present disclosure can exhibit a high pummel adhesion value in a range of from about 7.5 to about 10, from about 7 to about 10, from about 8 to 10, from about 9 to about 10, of at least 7, at least 7.5, at least 8, or at least 9, and also demonstrate good impact properties with an MBH in a range of from about 20 to 24 feet to about, or of at least 20 feet. This is contrary to conventional wisdom regarding the relationship between MBH and pummel adhesion described above. In impact data on this type of laminate construction, in 2 out of 3 ball drop tests using a 5 lb. ball from 24 ft. (7.32 meters), the ball did not penetrate the glass laminate.

For architecture applications the goal can be to minimize deflection under load and to maximize post-breakage glass retention. For these applications a stiff interlayer such as polycarbonate or SentryGlas® from DuPont can be widely used. Tests of glass laminates made using 0.89 mm thick SentryGlas® and two sheets of 1 mm thick Gorilla® Glass demonstrated that laminates made using Gorilla® Glass and SentryGlas® have exceptionally high pummel adhesion values of about 10 and reduced deflection upon loading as demonstrated by an edge strength of approximately twice that of similar laminates made using standard unstiffened PVB. Thin glass laminates with ionomer interlayers (such as SentryGlas®) according to the present description can have a high pummel adhesion value in a range of from about 7.5 to about 10, from about 7 to about 10, from about 8 to 10, from about 9 to about 10, of at least 7, at least 7.5, at least 8, or at least 9, and can demonstrate good impact properties with an MBH in a range of from about 20 to 24 feet or at least 20 feet.

FIG. 2 is a cross-sectional illustration of a laminated glass structure according to another embodiment. With reference to FIG. 2, there can be three or more thin glass sheets 22, 24, 26 with polymer interlayers 28 and 30 between adjacent glass sheets. In such an embodiment, it can be advantageous to chemically strengthen only the outer glass sheets 22 and 26, while the inner glass sheet 24 (or sheets) can be conventionally strengthened glass. In another embodiment, the inner glass sheet(s) can be made of soda lime glass. If additional stiffness is required, the inner or central glass sheet 24 can be a thick glass sheet having a thickness of at least 1.5 mm, at least 2.0 mm or at least 3.0 mm. Alternatively, one or more of the inner glass sheets, or all of the inner glass sheets in the laminate 20 can be chemically strengthened glass sheets, thin glass sheets, or thin chemically strengthened glass sheets.

Examples of ion-exchangeable glasses suitable for forming chemically strengthened glass sheets for use in glass laminates according to embodiments of the present disclosure are alkali aluminosilicate glasses or alkali aluminoborosilicate glasses, though other glass compositions are contemplated. As used herein, “ion exchangeable” means that a glass is capable of exchanging cations located at or near the surface of the glass with cations of the same valence that are either larger or smaller in size. One exemplary glass composition comprises SiO₂, B₂O₃ and Na₂O, where (SiO₂+B₂O₃)≧66 mol.%, and Na₂O≧9 mol.%. In one embodiment, the glass sheets include at least 6 wt. % aluminum oxide. In a further embodiment, a glass sheet includes one or more alkaline earth oxides, such that a content of alkaline earth oxides is at least 5 wt. %. Suitable glass compositions, in some embodiments, further comprise at least one of K₂O, MgO, and CaO. In a particular embodiment, the glass can comprise 61-75 mol.% SiO₂, 7-15 mol.% Al₂O₃, 0-12 mol.% B₂O₃, 9-21 mol.% Na₂O, 0-4 mol.% K₂O, 0-7 mol.% MgO, and 0-3 mol.% CaO.

A further exemplary glass composition suitable for forming glass laminates comprises 60-70 mol.% SiO₂, 6-14 mol.% Al₂O₃, 0-15 mol.% B₂O₃, 0-15 mol.% Li₂O, 0-20 mol.% Na₂O, 0-10 mol.% K₂O, 0-8 mol.% MgO, 0-10 mol.% CaO, 0-5 mol.% ZrO₂, 0-1 mol.% SnO₂, 0-1 mol.% CeO₂, less than 50 ppm As₂O₃, and less than 50 ppm Sb₂O₃, where 12 mol.%≦(Li₂O+Na₂O+K₂O)≦20 mol.% and 0 mol.%≦(MgO+CaO)≦10 mol.%. A still further exemplary glass composition comprises 63.5-66.5 mol.% SiO₂, 8-12 mol.% Al₂O₃, 0-3 mol.% B₂O₃, 0-5 mol.% Li₂O, 8-18 mol.% Na₂O, 0-5 mol.% K₂O, 1-7 mol.% MgO, 0-2.5 mol.% CaO, 0-3 mol.% ZrO₂, 0.05-0.25 mol.% SnO₂, 0.05-0.5 mol.% CeO₂, less than 50 ppm As₂O₃, and less than 50 ppm Sb₂O₃, where 14 mol.%≦(Li₂O+Na₂O+K2O)≦18 mol.% and 2 mol.%≦(MgO+CaO)≦7 mol.%. In another embodiment, an alkali aluminosilicate glass comprises, consists essentially of, or consists of 61-75 mol.% SiO₂, 7-15 mol.% Al₂O₃, 0-12 mol.% B₂O₃, 9-21 mol.% Na₂O, 0-4 mol.% K₂O, 0-7 mol.% MgO, and 0-3 mol.% CaO.

In a particular embodiment, an alkali aluminosilicate glass comprises alumina, at least one alkali metal and, in some embodiments, greater than 50 mol.% SiO₂, in other embodiments at least 58 mol.% SiO₂, and in still other embodiments at least 60 mol.% SiO₂, wherein the ratio

$$\frac{{Al}_{2} {O}_{3} + {B}_{2} {O}_{3}}{\sum modifiers} > 1 ,$$

wherein the ratio the components are expressed in mol.% and the modifiers are alkali metal oxides. This glass, in particular embodiments, comprises, consists essentially of, or consists of 58-72 mol.% SiO₂, 9-17 mol.% Al₂O₃, 2-12 mol.% B₂O₃, 8-16 mol.% Na₂O, and 0-4 mol.% K₂O, wherein the ratio

$$\frac{{Al}_{2} {O}_{3} + {B}_{2} {O}_{3}}{\sum modifiers} > 1.$$

In yet another embodiment, an alkali aluminosilicate glass substrate comprises, consists essentially of, or consists of 60-70 mol.% SiO₂, 6-14 mol.% Al₂O₃, 0-15 mol.% B₂O₃, 0-15 mol.% Li₂O, 0-20 mol.% Na₂O, 0-10 mol.% K₂O, 0-8 mol.% MgO, 0-10 mol.% CaO, 0-5 mol.% ZrO₂, 0-1 mol.% SnO₂, 0-1 mol.% CeO₂, less than 50 ppm As₂O₃, and less than 50 ppm Sb₂O₃, wherein 12 mol.%≦Li₂O+Na₂O+K₂O≦20 mol.% and 0 mol.%≦MgO+CaO≦10 mol.%. In still another embodiment, an alkali aluminosilicate glass comprises, consists essentially of, or consists of 64-68 mol.% SiO₂, 12-16 mol.% Na₂O, 8-12 mol.% Al₂O₃, 0-3 mol.% B₂O₃, 2-5 mol.% K₂O, 4-6 mol.% MgO, and 0-5 mol.% CaO, wherein 66 mol.%≦SiO₂+B₂O₃+CaO≦69 mol.%, Na₂O+K₂O+B₂O₃+MgO+CaO+SrO>10 mol.%, 5 mol.%≦MgO+CaO+SrO≦8 mol.%, (Na₂O+B₂O₃)≦Al₂O₃ 2 mol.%, 2 mol.%≦Na₂O≦Al₂O₃≦6 mol.%, and 4 mol.%≦(Na₂O+K₂O)≦Al₂O₃ 10 mol.%.

The chemically-strengthened glass as well as the non-chemically-strengthened glass, in some embodiments, can be batched with 0-2 mol.% of at least one fining agent including, but not limited to, Na₂SO₄, NaCl, NaF, NaBr, K₂SO₄, KCl, KF, KBr, and/or SnO₂. In one exemplary embodiment, sodium ions in the glass can be replaced by potassium ions from the molten bath, though other alkali metal ions having a larger atomic radius, such as rubidium or cesium, can replace smaller alkali metal ions in the glass. According to particular embodiments, smaller alkali metal ions in the glass can be replaced by Ag+ ions. Similarly, other alkali metal salts such as, but not limited to, sulfates, halides, and the like can be used in the ion exchange process.

Replacement of smaller ions by larger ions at a temperature below that at which the glass network can relax produces a distribution of ions across the surface of the glass that results in a stress profile. The larger volume of the incoming ion produces a compressive stress (CS) on the surface and tension (central tension (CT)) in the center region of the glass. Compressive stress is generally related to the central tension by the relationship:

$$CS = CT ( \frac{t - 2 DOL}{DOL} )$$

where t represents the total thickness of the glass sheet and DOL represents the depth of exchange, also referred to as depth of layer.

According to various embodiments, thin glass laminates comprising one or more sheets of ion-exchanged glass and having a specified depth of layer versus compressive stress profile can possess an array of desired properties, including low weight, high impact resistance, and improved sound attenuation.

In one embodiment, a chemically-strengthened glass sheet can have a surface compressive stress of at least 300 MPa, e.g., at least 400, 500, or 600 MPa, a depth of at least about 20 μm (e.g., at least about 20, 25, 30, 35, 40, 45, or 50 μm) and/or a central tension greater than 40 MPa (e.g., greater than 40, 45, or 50 MPa) and less than 100 MPa (e.g., less than 100, 95, 90, 85, 80, 75, 70, 65, 60, or 55 MPa).

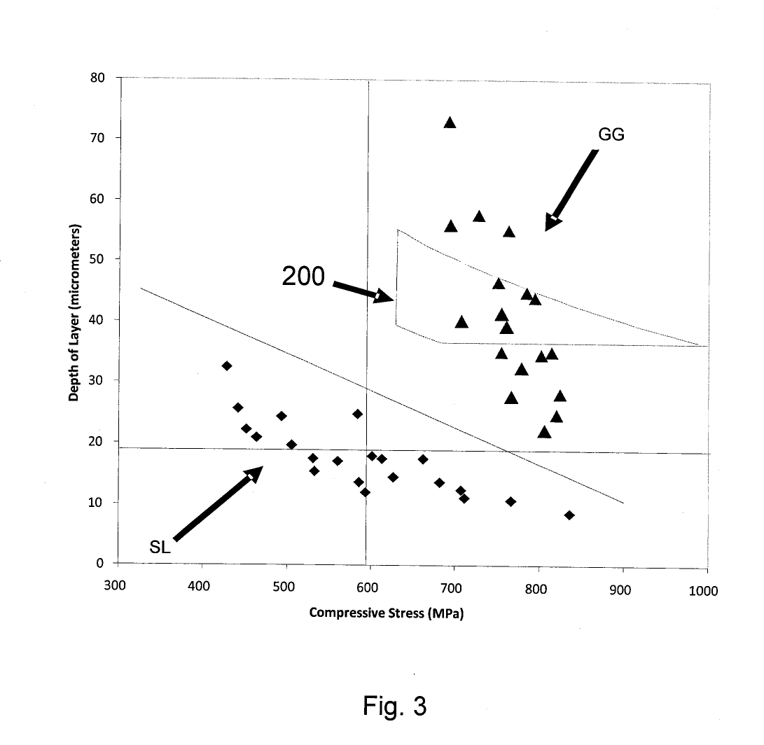

FIG. 3 is a plot of depth of layer versus compressive stress for various glass sheets according to several embodiments. With reference to FIG. 3, data from a comparative soda lime glass are designated by diamonds SL while data from chemically-strengthened aluminosilicate glasses are designated by triangles GG. As shown in the illustrated plot, the depth of layer versus surface compressive stress data for chemically-strengthened sheets can be defined by a compressive stress of greater than about 600 MPa, and a depth of layer greater than about 20 micrometers. A region 200 can be defined by a surface compressive stress greater than about 600 MPa, a depth of layer greater than about 40 micrometers, and a tensile stress between about 40 and 65 MPa. Independently of or in conjunction with the foregoing relationships, chemically-strengthened glass can have depth of layer that is expressed in terms of the corresponding surface compressive stress. In one example, the near surface region extends from a surface of the first glass sheet to a depth of layer (in micrometers) of at least 65-0.06(CS), where CS is the surface compressive stress and has a value of at least 300 MPa. This linear relationship is represented by the sloped line in FIG. 3. Satisfactory CS and DOL levels are located above the line 65-0.06(CS) on a plot of DOL on the y-axis and CS on the x-axis.

In a further example, the near surface region extends from a surface of the first glass sheet to a depth of layer (in micrometers) having a value of at least B-M(CS), where CS is the surface compressive stress and is at least 300 MPa and where B can range from about 50 to 180 (e.g., 60, 70, 80, 90, 100, 110, 120, 130, 140, 150, 160±5) and M can range independently from about −0.2 to −0.02 (e.g., −0.18, −0.16, −0.14, −0.12, −0.10, −0.08, −0.06, −0.04±−0.01).

A modulus of elasticity of a chemically-strengthened glass sheet can range from about 60 GPa to 85 GPa (e.g., 60, 65, 70, 75, 80 or 85 GPa). The modulus of elasticity of the glass sheet(s) and the polymer interlayer can affect both the mechanical properties (e.g., deflection and strength) and the acoustic performance (e.g., transmission loss) of the resulting glass laminate.

Exemplary glass sheet forming methods can include fusion draw and slot draw processes, which are each examples of a down-draw process, as well as float processes. The fusion draw process uses a drawing tank having a channel for accepting molten glass raw material. The channel includes weirs open at the top along the length of the channel on both sides thereof. When the channel fills with molten material, the molten glass overflows the weirs. Due to gravity, the molten glass flows down the outside surfaces of the drawing tank. These outside surfaces extend down and inwardly so they join at an edge below the drawing tank. The two flowing glass surfaces join at this edge to fuse and form a single flowing sheet. The fusion draw method offers the advantage that, because the two glass films flowing over the channel fuse together, neither outside surface of the resulting glass sheet comes in contact with any part of the apparatus. Thus, the surface properties of the fusion drawn glass sheet are not affected by such contact.

The slot draw method is distinct from the fusion draw method. Here the molten raw material glass is provided to a drawing tank. The bottom of the drawing tank has an open slot with a nozzle that extending the length of the slot. The molten glass flows through the slot/nozzle and is drawn downward as a continuous sheet into an annealing region. The slot draw process generally provides a thinner sheet than the fusion draw process because a single sheet is drawn through the slot, rather than two sheets being fused together.

Down-draw processes produce glass sheets having a uniform thickness and possessing surfaces that are relatively pristine. Because the strength of the glass surface is controlled by the amount and size of surface flaws, a pristine surface with minimal contact has a higher initial strength. When this high strength glass is then chemically strengthened, the resultant strength can be higher than that of a surface that has been a lapped and polished. Down-drawn glass can be drawn to a thickness of less than about 2 mm. In addition, down drawn glass has a very flat, smooth surface that can be used in its final application without costly grinding and polishing.

In the float glass method, a sheet of glass that can be characterized by smooth surfaces and uniform thickness made by floating molten glass on a bed of molten metal, typically tin. In an exemplary process, molten glass is fed onto the surface of the molten tin bed forming a floating ribbon. As the glass ribbon flows along the tin bath, the temperature is gradually decreased until a solid glass sheet can be lifted from the tin onto rollers. Once off the bath, the glass sheet can be cooled further and annealed to reduce internal stress.

Glass laminates for automotive glazing and other applications can be formed using a variety of processes. In an exemplary process, one or more sheets of chemically-strengthened glass sheets are assembled in a pre-press with a polymer interlayer, tacked into a pre-laminate, and finished into an optically clear glass laminate. The assembly, in an exemplary embodiment having two glass sheets, can be formed by laying down a first sheet of glass, overlaying a polymer interlayer such as a PVB sheet, laying down a second sheet of glass, and then trimming the excess PVB to the edges of the glass sheets. An exemplary tacking step can include expelling most of the air from the interfaces and partially bonding the PVB to the glass sheets. An exemplary finishing step, typically carried out at elevated temperatures and pressures, completes the mating of each of the glass sheets to the polymer interlayer.

In some embodiments, a thermoplastic material such as PVB can be applied as a preformed polymer interlayer. The thermoplastic layer can, in certain embodiments, have a thickness of at least 0.125 mm (e.g., 0.125, 0.25, 0.375, 0.5, 0.75, 0.76 or 1 mm). The thermoplastic layer can cover most or substantially all of the two opposed major faces of the glass. It can also cover the edge faces of the glass. The glass sheet(s) in contact with the thermoplastics layer can be heated above the softening point of the thermoplastic, such as, for example, at least 5° C. or 10° C. above the softening point, to promote bonding of the thermoplastic material to the glass. The heating can be performed with the glass ply in contact with the thermoplastic layers under pressure.

Exemplary non-limiting polymer interlayer materials are summarized in Table 1, which provides glass transition temperature and modulus for each material. Glass transition temperature and modulus data were determined from technical data sheets available from the vendor or using a DSC 200 Differential Scanning calorimeter (Seiko Instruments Corp., Japan) or by an ASTM D638 method for the glass transition and modulus data, respectively. A further description of the acrylic/silicone resin materials used in the ISD resin is disclosed in U.S. Pat. No. 5,624,763, and a description of the acoustic modified PVB resin is disclosed in Japanese Patent No. 05138840, the contents of each are hereby incorporated by reference in their entirety.

TABLE 1
Exemplary Polymer Interlayer Materials

| | | psi | |
|---|---|---|---|
| Interlayer Material | T_{g} (° C.) | (MPa) | |
| EVA (STR Corp., Enfield, CT) | −20 | 750-900 | (5.2-6.2) |
| EMA (Exxon Chemical Co., Baytown, | −55 | <4,500 | (27.6) |
| TX) | | | |
| EMAC (Chevron Corp., | −57 | <5,000 | (34.5) |
| Orange, TX) | | | |
| PVC plasticized (Geon Company, | −45 | <1500 | (10.3) |
| Avon Lake, OH) | | | |
| PVB plasticized (Solutia, | 0 | <5000 | (34.5) |
| St. Louis, MO) | | | |
| Polyethylene, Metallocene- | −60 | <11,000 | (75.9) |
| catalyzed (Exxon Chemical | | | |
| Co., Baytown, TX) | | | |

| | | |
|---|---|---|
| Polyurethane Semi-rigid | −49 | 54 |
| (78 Shore A) (Stephens Urethane) | | |
| ISD resin (3M Corp., Minneapolis, | −20 | |
| MN) | | |
| Acoustic modified PVB | | 140 |
| (Sekisui KKK, Osaka, Japan) | | |
| Uvekol A (liquid curable resins) | | |
| (Cytec, Woodland Park, NJ) | | |

A modulus of elasticity of an exemplary polymer interlayer can range from about 1 MPa to 300 MPa (e.g., about 1, 5, 10, 20, 25, 50, 100, 150, 200, 250, or 300 MPa). At a loading rate of 1 Hz, a modulus of elasticity of a standard PVB interlayer can be about 15 MPa, and a modulus of elasticity of an acoustic grade PVB interlayer can be about 2 MPa. In other embodiments, one or more polymer interlayers can be incorporated into a glass laminate. A plurality of interlayers can provide complimentary or distinct functionality, including adhesion promotion, acoustic control, UV transmission control, and/or IR transmission control.

During an exemplary lamination process, an interlayer is typically heated to a temperature effective to soften the interlayer, which promotes a conformal mating of the interlayer to respective surfaces of the glass sheets and adhesion of the interlayer to the glass sheets. For PVB, for example, a lamination temperature can be about 140° C. Mobile polymer chains within the interlayer material develop bonds with the glass surfaces, which promote adhesion. Elevated temperatures also accelerate the diffusion of residual air and/or moisture from the glass-polymer interface. An optional application of pressure can promote flow of the interlayer material and suppress bubble formation that otherwise would be induced by the combined vapor pressure of water and air trapped at the interfaces. To suppress bubble formation, heat and pressure can also be simultaneously applied to the assembly in an autoclave.

Glass laminates can be formed using substantially identical glass sheets or, in alternative embodiments, characteristics of the individual glass sheets such as composition, ion exchange profile and/or thickness can be independently varied to form an asymmetric glass laminate.

Exemplary glass laminates can be used to provide beneficial effects, including the attenuation of acoustic noise, reduction of UV and/or IR light transmission, and/or enhancement of the aesthetic appeal of a window opening. Individual glass sheets comprising exemplary glass laminates can be characterized by one or more attributes, including composition, density, thickness, surface metrology, as well as various properties including mechanical, optical, and/or sound-attenuation properties.

Weight savings associated with using thinner glass sheets are exhibited in Table 2 below which provides glass weight, interlayer weight, and glass laminate weight for exemplary glass laminates having a real dimension of 110 cm×50 cm and a polymer interlayer comprising a 0.76 mm thick sheet of PVB having a density of 1.069 g/cm3.

TABLE 2
Physical properties of glass sheet/PVB/glass sheet laminate.

| Thickness | Glass Weight | PVB weight | Laminate |
|---|---|---|---|
| (mm) | (g) | (g) | weight (g) |
| 4 | 5479 | 445 | 11404 |
| 3 | 4110 | 445 | 8664 |
| 2 | 2740 | 445 | 5925 |
| 1.4 | 1918 | 445 | 4281 |
| 1 | 1370 | 445 | 3185 |
| 0.7 | 959 | 445 | 2363 |
| 0.5 | 685 | 445 | 1815 |

With reference to Table 2, by decreasing the thickness of the individual glass sheets, the total weight of the laminate can be dramatically reduced. In some applications, a lower total weight translates directly to greater fuel economy. The glass laminates can be adapted for use, for example, as panels, covers, windows or glazings, and configured to any suitable size and dimension. In certain embodiments, the glass laminates can include a length and width that independently vary from 10 cm to 1 m or more (e.g., 0.1, 0.2, 0.5, 1, 2, or 5 m). Independently, the glass laminates can have an area of greater than 0.1 m², e.g., greater than 0.1, 0.2, 0.5, 1, 2, 5, 10, or 25 m². Of course these dimensions are exemplary only and should not limit the scope of the claims appended herewith.

Exemplary glass laminates can be substantially flat or shaped for certain applications. For example, glass laminates can be formed as bent or shaped parts for use as windshields or cover plates. The structure of a shaped glass laminate can also be simple or complex. In certain embodiments, a shaped glass laminate can have a complex curvature where the glass sheets have a distinct radius of curvature in two independent directions. Such shaped glass sheets can thus be characterized as having a “cross curvature,” where the glass is curved along an axis parallel to a given dimension and also curved along an axis perpendicular to the same dimension. An automobile sunroof, for example, typically measures about 0.5 m by 1.0 m and has a radius of curvature of 2 to 2.5 m along the minor axis and a radius of curvature of 4 to 5 m along the major axis.

Shaped glass laminates according to certain embodiments can be defined by a bend factor, where the bend factor for a given part is substantially equal to the radius of curvature along a given axis divided by the length of that axis. Thus, an automotive sunroof having radii of curvature of 2 m and 4 m along respective axes of 0.5 m and 1.0 m, the bend factor along each axis can be 4. Shaped glass laminates can also have a bend factor ranging from 2 to 8 or more.

Methods for bending and/or shaping glass laminates can include gravity bending, press bending and methods that are hybrids thereof. In a traditional method of gravity bending, thin, flat sheets of glass can be formed into curved shapes such as automobile windshields, cold, pre-cut single or multiple glass sheets by placing them onto a rigid, pre-shaped, peripheral support surface of a bending fixture. The bending fixture can be made using a metal or a refractory material. In an exemplary method, an articulating bending fixture can be used. Prior to bending, the glass typically is supported only at a few contact points. The glass is heated, usually by exposure to elevated temperatures in a lehr, which softens the glass allowing gravity to sag or slump the glass into conformance with the peripheral support surface. The entire support surface generally will then be in contact with the periphery of the glass.

Another bending technique is press bending where flat glass sheets are heated to a temperature corresponding substantially to the softening point of the glass. The heated sheets are then pressed or shaped to a desired curvature between male and female mold members having complementary shaping surfaces. In some embodiments, a combination of gravity bending and press bending techniques can be employed.

In other embodiments, a chemically-strengthened glass sheet can have a thickness not exceeding 1.4 mm or less than 1.0 mm. In further embodiments, the thickness of a chemically-strengthened glass sheet can be substantially equal to a thickness of a second glass opposing outer glass sheet or an inner glass sheet, such that the respective thicknesses vary by no more than 5%, e.g., less than 5, 4, 3, 2 or 1%. According to additional embodiments, the second (e.g., inner) glass sheet can have a thickness less than 2.0 mm or less than 1.4 mm. Without being bound by theory, Applicants believe that a glass laminate comprising opposing glass sheets having substantially identical thicknesses can provide a maximum coincidence frequency and corresponding maximum in the acoustic transmission loss at the coincidence dip. Such a design can provide beneficial acoustic performance for the glass laminate, for example, in automotive applications.

Laminate glass structures as disclosed herein demonstrate excellent durability, impact resistance, toughness, and scratch resistance. The strength and mechanical impact performance of a glass sheet or laminate can be limited by defects in the glass, including both surface and internal defects. When a glass laminate is impacted, the impact point is placed into compression, while a ring or “hoop” around the impact point as well as the opposite face of the impacted sheet, are put into tension. Typically, the origin of failure can be at a flaw, usually on the glass surface, at or near the point of highest tension. This can occur on the opposite face, but can also occur within the ring. If a flaw in the glass is put into tension during an impact event, the flaw will likely propagate, and the glass will break. Thus, a high magnitude and depth of compressive stress (depth of layer) is preferable. The addition of controlled flaws to exemplary surfaces of embodiments described herein and acid etch treatment of surfaces of embodiments described herein can provide such laminates with a desired breakage performance upon internal and external impact events.

Due to chemical strengthening, one or both of the external surfaces of glass laminates disclosed herein can be under compression. For flaws to propagate and failure to occur, tensile stress from an impact must exceed the surface compressive stress at the tip of the flaw. In some embodiments, the high compressive stress and high depth of layer of chemically-strengthened glass sheets can enable the use of thinner glass than in the case of non-chemically-strengthened glass.

In additional embodiments, a glass laminate can comprise inner and outer glass sheets such as, but not limited to, chemically-strengthened glass sheets wherein the outer-facing chemically-strengthened glass sheet has a surface compressive stress of at least 300 MPa (e.g., at least 400, 450, 500, 550, 600, 650, 700, 750 or 800 MPa), a depth of at least about 20 μm (e.g., at least about 20, 25, 30, 35, 40, 45, or 50 μm) and/or a central tension greater than 40 MPa (e.g., greater than 40, 45, or 50 MPa) and less than 100 MPa (e.g., less than 100, 95, 90, 85, 80, 75, 70, 65, 60, or 55 MPa). Such embodiments can also include an inner-facing glass sheet (e.g., an inner chemically-strengthened glass sheet) having a surface compressive stress of from one-third to one-half the surface compressive stress of the outer chemically-strengthened glass sheet, or equal that of the outer glass sheet.

In addition to their mechanical properties, the acoustic damping properties of exemplary glass laminates have also been evaluated. As will be appreciated by a skilled artisan, laminated structures with a central acoustic interlayer 16, such as a commercially available acoustic PVB interlayer, can be used to dampen acoustic waves. The chemically-strengthened glass laminates disclosed herein can dramatically reduce acoustic transmission while using thinner (and lighter) structures also possessing the requisite mechanical properties for many glazing applications.

One embodiment of the present disclosure includes thin glass laminate structures 10 and 20 made using stiff, rigid interlayers combined with at least one or more thin chemically strengthened outer glass sheets and one or more inner glass sheets. The stiff interlayers can provide improved load/deformation properties to laminates made using thin glass. Other embodiments can include soft interlayers, such as acoustic sound dampening interlayers. Still other embodiments can employ soft acoustic (e.g., sound dampening) interlayers in combination with stiff interlayers, such as SentryGlas® interlayers.

Acoustic damping can be determined by interlayer shear modulus and loss factor of the interlayer material. When the interlayer is a large fraction of the total laminate thickness, the bending rigidity (load deformation properties) can be largely determined by Young's modulus. Using multilayer interlayers, these properties can be adjusted independently resulting in a laminate with satisfactory rigidity and acoustic damping.

Commercially available materials that are candidates for use as a polymer interlayer in a glass laminate according to the present disclosure include, but are not limited to, SentryGlas® Ionomer, acoustic PVB (e.g. Sekisui's thin 0.4 mm thick acoustic PVB), EVA, TPU, stiff PVB (e.g. Saflex DG), and standard PVB. The use of all PVB layers, in the case of a multi-layer interlayer, can be advantageous because of the chemical compatibility between the layers. SentryGlas® is less chemically compatible with other interlayer materials such as EVA or PVB and can require a binder film (e.g., a polyester film) between the layers.

In a first experiment, glass laminates including PVB interlayers and laminates including SentryGlas® interlayers were prepared using a vacuum bag to de-air and tack the laminates and an autoclave run at cycles in the ranges specified by Solutia Inc. (PVB supplier) and DuPont (SentryGlas® supplier). The SentryGlas® sheets were stored in a metal foil lined bag until use, thereby ensuring that the SentryGlas® sheet was dry (<0.2% moisture). For PVB interlayers, exemplary embodiments can have a sheet moisture level of <0.6%. The laminates were tested using a standard pummel test for measuring adhesion of glass to the interlayer for laminated glass. The pummel test includes conditioning laminates at 0 F (−18 C) followed by impacting the samples with a 1 lb. hammer to shatter the glass. Adhesion was judged by the amount of exposed interlayer material resulting from glass that has fallen off the interlayer, e.g., the pummel adhesion value.

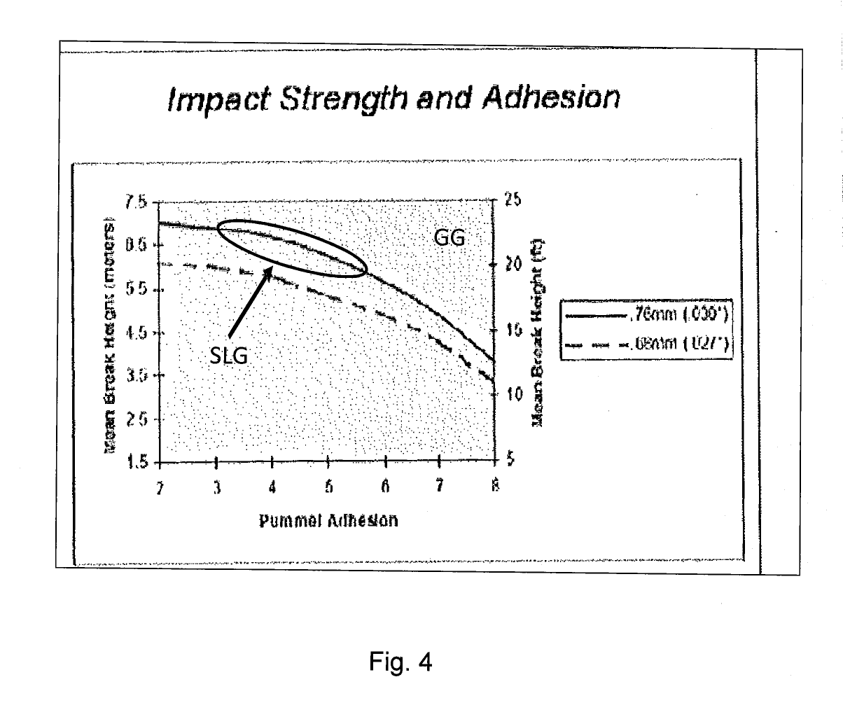

The relationship between the penetration resistance and pummel adhesion for PVB laminated with standard auto glass, e.g., 2.1 mm thick or 2.3 mm thick soda lime glass, is illustrated in FIG. 4. With reference to FIG. 4, penetration resistance, as measured by MBH, can decrease to unacceptable levels as adhesion is increased. It is known that, for thick soda lime glass laminates, impact resistance is determined primarily by PVB-glass adhesion and properties of the PVB interlayer, with little contribution from the glass. As shown in FIG. 4, soda lime glass-PVB laminates require that a compromise be made between acceptable penetration resistance and adhesion.

Embodiments of the present disclosure can provide glass laminates for automotive, vehicular, appliance, electronics, architectural, and other applications with high levels of adhesion between at least one glass sheet and polymer layer with a pummel adhesion value of in a range from about 7 to about 10, from about 8 to 10, from about 9 to about 10, of at least 7, at least 8, or at least 9. Such laminates having a high adhesion between the glass and a polymer layer exhibit outstanding post-breakage glass retention properties. These laminates also demonstrate good combination of high adhesion and a level of high penetration resistance of at least 20 feet MBH, which is contrary to poor penetration resistance at high adhesion exhibited by conventional soda lime glass laminates. Exemplary laminates described herein do not need adhesion control agents to provide acceptable penetration resistance or adhesion to glass. Laminated glass made with chemically strengthened glass, such as Corning® Gorilla® Glass, and either poly vinyl butyral (PVB) or SentryGlas® ionomeric interlayers have unusually high adhesion when compared to laminated glass made with soda lime glass for applications such as automotive and architectural glazing. High adhesion is beneficial as it provides a high level of glass retention after breakage. In addition, laminates made using Gorilla® Glass with PVB interlayers combine the desirable properties of both high adhesion and high penetration height (high penetration resistance).

By contrast, soda lime glass/PVB laminates have poor penetration resistance at high adhesion levels. In addition, the high adhesion of Gorilla® Glass to SentryGlas® eliminates the need for an adhesion promoter and does not depend on which side of the Gorilla® Glass the SentryGlas® contacts, as is the case for soda lime glass laminates.

Exemplary embodiments include light-weight thin glass laminates having acceptable mechanical and/or acoustic damping properties. Additional embodiments can include polymer interlayers and laminated glass structures whose mechanical and acoustic properties can be independently engineered by adjustments of properties of the individual layers of the polymer interlayer. The layers of the laminated glass structures described herein can be individual layers of sheet that are bonded together during the lamination process. The layers of the interlayer structures described herein can be coextruded together to form a single interlayer sheet with multiple layers.

While this description may include many specifics, these should not be construed as limitations on the scope thereof, but rather as descriptions of features that may be specific to particular embodiments. Certain features that have been heretofore described in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and may even be initially claimed as such, one or more features from a claimed combination may in some cases be excised from the combination, and the claimed combination may be directed to a subcombination or variation of a subcombination.

Similarly, while operations are depicted in the drawings or figures in a particular order, this should not be understood as requiring that such operations be performed in the particular order shown or in sequential order, or that all illustrated operations be performed, to achieve desirable results. In certain circumstances, multitasking and parallel processing may be advantageous.

As shown by the various configurations and embodiments illustrated in FIGS. 1-4, various embodiments for laminated glass structures having high glass to polymer interlayer adhesion have been described.

While preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What is claimed is:

1. A glass laminate structure comprising:
a first glass sheet having a thickness of less than 2 mm;
a second glass sheet having a thickness of less than 2 mm; and
a first polymer interlayer between the first and second glass sheets, the first polymer interlayer adhering to the first and second glass sheets,
wherein the glass laminate structure has a pummel value of at least 7.

2. The glass laminate structure of claim 1, wherein the glass laminate structure has a pummel value of at least 8 or of at least 9.

3. The glass laminate structure of claim 1, wherein the glass laminate structure has a penetration resistance of at least 20 feet mean break height.

4. The glass laminate structure of claim 1, wherein one or both of the first and second glass sheets is chemically strengthened.

5. The glass laminate structure of claim 1, wherein the second glass sheet is annealled.

6. The glass laminate structure of claim 1, wherein one or both of the first and second glass sheets has a thickness not exceeding 1.5 mm or not exceeding 1 mm.

7. The glass laminate structure of claim 1, wherein the interlayer is formed of a material selected from the group consisting of an ionomer, a polycarbonate, polyvinyl butyral, acoustic polyvinyl butyral, ethylene vinyl acetate, and thermoplastic polyurethane.

8. The glass laminate structure of claim 1 further comprising a second polymer interlayer between the first and second glass sheets.

9. The glass laminate structure of claim 7, wherein the second polymer interlayer is formed from a different material than the first polymer interlayer.

10. The glass laminate structure of claim 7 wherein the second polymer interlayer has a different thickness than the first polymer interlayer.

11. The glass laminate structure of claim 1 wherein the first glass sheet has a different thickness than the second glass sheet.

12. The glass laminate structure of claim 1, wherein the interlayer has a thickness in a range from about 0.38 mm to about 2.5 mm or from about 0.76 mm to about 0.81 mm.

13. The glass laminate structure of claim 1, wherein the glass composition of the first or second glass layer comprises SiO₂, B₂O₃ and Na₂O, where (SiO₂+B₂O₃)≧66 mol.%, and Na₂O≧9 mol.%.

14. The glass laminate structure of claim 1, wherein the first or second glass layer is a chemically-strengthened glass sheet having a surface compressive stress of at least 300 MPa, a depth of at least 20 μm, and a central tension greater than 40 MPa and less than 100 MPa.

15. The glass laminate structure of claim 1, wherein the first or second glass layer is a chemically-strengthened glass sheet having a modulus of elasticity ranging from about 60 GPa to 85 GPa.

16. A method of forming a glass laminate structure comprising the steps of:
providing a first glass sheet, a second glass sheet, and a polymer interlayer;
stacking the interlayer on the first glass sheet;
stacking the second glass sheet on the interlayer to form an assembled stack; and
heating the assembled stack to a temperature at or above the softening temperature of the interlayer to laminate the interlayer to the first glass sheet and the second glass sheet,
wherein adhesion promoters are not employed between any of the interlayer, the first glass sheet, and the second glass sheet.

17. The method of claim 16, wherein the glass laminate structure has a pummel value of at least 7.

18. The method of claim 16, wherein the glass laminate structure has a penetration resistance of at least 20 feet mean break height.

19. The method of claim 16, wherein one or both of the first and second glass sheets is chemically strengthened.

20. The method of claim 16, wherein the interlayer is formed of a material selected from the group consisting of an ionomer, a polycarbonate, polyvinyl butyral, acoustic polyvinyl butyral, ethylene vinyl acetate, and thermoplastic polyurethane.

21. A process of forming a glass laminate structure comprising the steps of:
providing a first chemically-strengthened glass sheet, a second glass sheet and a polymer interlayer;
stacking the interlayer on the first glass sheet;
stacking the second glass sheet on the interlayer to form an assembled stack; and
heating the assembled stack to a temperature at or above the softening temperature of the interlayer to laminate the interlayer to the first glass sheet and the second glass sheet,
wherein adhesion promoters are not employed between any of the interlayer, the first glass sheet, and the second glass sheet such that the laminate structure has a pummel value of at least 7 and a penetration resistance of at least 20 feet mean break height.
